(19) United States
(12) Patent Application Publication
(10) Pub. No.: US 2013/0050303 A1
(43) Pub. Date: Feb. 28, 2013

(54) DEVICE AND METHOD FOR IMAGE PROCESSING AND AUTOSTEREOSCOPIC IMAGE DISPLAY APPARATUS

(71) Applicants: Nao MISHIMA, Tokyo (JP); Kenichi Shimoyama, Tokyo (JP); Takeshi Mita, Kanagawa (JP)

(72) Inventors: Nao MISHIMA, Tokyo (JP); Kenichi Shimoyama, Tokyo (JP); Takeshi Mita, Kanagawa (JP)

(21) Appl. No.: 13/415,175

(22) Filed: Mar. 8, 2012

Related U.S. Application Data
(63) Continuation of application No. PCT/JP2011/069064, filed on Aug. 24, 2011.

(51) Int. Cl. G09G 5/10

(52) U.S. Cl. 345/694

(57) ABSTRACT

According to an embodiment, an image processing device includes a specifying unit configured to specify, from among a plurality of parallax images each having a mutually different parallax, a pixel area containing at least a single pixel; and a modifying unit configured to, depending on a positional relationship between each pixel in the pixel area specified from among the parallax images and a viewpoint position of a viewer, modify the pixel area into a modified pixel area that contains a pixel which is supposed to be viewed from the viewpoint position.

### CROSS-REFERENCE TO RELATED APPLICATIONS

This application is a continuation of PCT international application Ser. No. PCT/JP2011/069064 filed on Aug. 24, 2011 which designates the United States; the entire contents of which are incorporated herein by reference.

### FIELD

Embodiments described herein relate generally to a device and a method for image processing as well as relate to a autostereoscopic display apparatus.

### BACKGROUND

Autostereoscopic display apparatuses are known that enable the viewers to view stereoscopic images without having to wear special glasses. Such a autostereoscopic display apparatus has a display panel with a plurality of pixels arranged thereon; includes a light ray control unit that is installed in front of the display panel and that controls the outgoing direction of a light ray coming out from each pixel; and displays a plurality of parallax images each having a mutually different parallax.

In such a autostereoscopic display apparatus, sometimes the light rays coming out from the pixels displaying a particular parallax image get partially mixed with the light rays coming out from the pixels displaying another parallax image, thereby leading to the occurrence of the crosstalk phenomenon. That may rob the user of the opportunity to view good stereoscopic images.

Despite that, in such a autostereoscopic display apparatus, it is not possible to reduce the occurrence of the crosstalk phenomenon with accuracy.

### BRIEF DESCRIPTION OF THE DRAWINGS

FIG. 1 is a diagrammatic illustration of a autostereoscopic display apparatus 1 according to a first embodiment;

FIG. 2 is an explanatory diagram for explaining the rotation of a visible area;

FIG. 3 is a block diagram of an image processing device 10;

FIG. 4 is a flowchart for explaining the operations performed in the image processing device 10;

FIG. 5 is an exemplary diagram of luminance profiles;

FIGS. 6A and 6B are explanatory diagrams for explaining the positional relationship between a display device 15 and a viewpoint;

FIG. 7 is a block diagram of an image processing device 20 according to a second embodiment; and

FIG. 8 is a block diagram of an image processing device 30 according to a third embodiment.

### DETAILED DESCRIPTION

According to one embodiment, an image processing device includes a specifying unit configured to specify, from among a plurality of parallax images each having a mutually different parallax, a pixel area containing at least a single pixel; and a modifying unit configured to, depending on a positional relationship between each pixel in the pixel area specified from among the parallax images and a viewpoint position of a viewer, modify the pixel area into a modified pixel area that contains a pixel which is supposed to be viewed from the viewpoint position.

### First Embodiment

An image processing device 10 according to a first embodiment is put to use in a autostereoscopic display apparatus 1 such as a TV, a PC, a smartphone, or a digital photo frame that enables the viewer to view stereoscopic images with the unaided eye. The autostereoscopic display apparatus 1 enables the viewer to view the stereoscopic images by displaying a plurality of parallax images each having a mutually different parallax. In the autostereoscopic display apparatus 1, a 3D display method such as the integral imaging method (II method) or the multi-viewpoint method can be implemented.

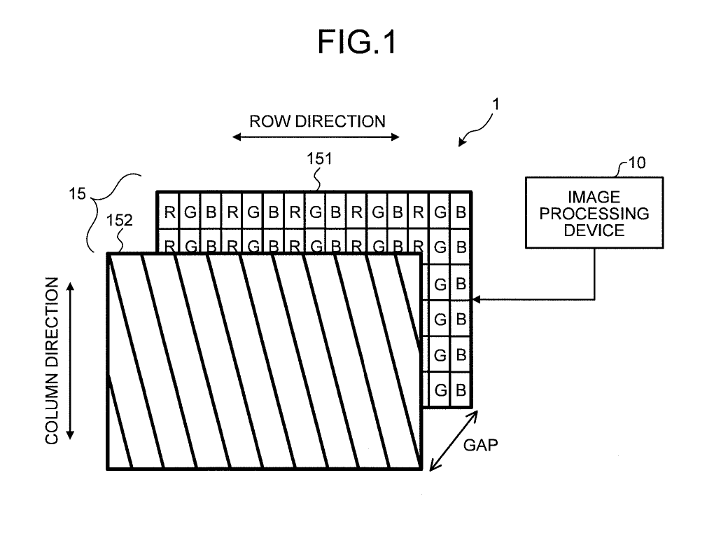

FIG. 1 is a diagrammatic illustration of the autostereoscopic display apparatus 1. The autostereoscopic display apparatus 1 includes the image processing device 10 and a display device 15. The display device 15 includes a display panel 151 and a light ray control unit 152.

The image processing device 10 modifies a plurality of parallax images that have been obtained, generates a stereoscopic image from the modified parallax images, and sends the stereoscopic image to the display panel 151. The details regarding the modification of parallax images are given later.

In a stereoscopic image, the pixels of the parallax images are assigned in such a way that, when the display panel 151 is viewed through the light ray control unit 152 from the viewpoint position of a viewer, one of the parallax images is seen by one eye of the viewer and another parallax image is seen by the other eye of the viewer. Thus, a stereoscopic image is generated by rearranging the pixels of each parallax image. Meanwhile, in a parallax image, a single pixel contains a plurality of sub-pixels.

The display panel 151 is a liquid crystal panel in which a plurality of sub-pixels having color components (such as R, G, and B) are arranged in a first direction (for example, in the row direction (in the horizontal direction) with reference to FIG. 1) as well as arranged in a second direction (for example, in the column direction (in the vertical direction) with reference to FIG. 1) in a matrix-like manner. Alternatively, the display panel can also be a flat panel such as an organic EL panel or a plasma panel. The display panel 151 illustrated in FIG. 1 is assumed to include a light source in the form of a backlight.

The light ray control unit 152 is disposed opposite to the display panel 151 and controls the outgoing direction of the light ray coming out from each sub-pixel on the display panel 151. In the light ray control unit 152, a plurality of optical openings, each extending in a linear fashion and each allowing a light ray to go out therethrough, is arranged in the first direction. For example, the light ray control unit 152 can be a lenticular sheet having a plurality of cylindrical lenses arranged thereon. Alternatively, the light ray control unit 152 can also be a parallax barrier having a plurality of slits arranged thereon. Meanwhile, the display panel 151 and the light ray control unit 152 have a certain distance (gap) maintained therebetween.

As illustrated in FIG. 1, the display panel 151 can have a vertical stripe arrangement in which the sub-pixels of the same color component are arranged in the second direction and each color component is repeatedly arranged in the first direction. In that case, the light ray control unit 152 is disposed in such a way that the extending direction of the optical openings has a predetermined tilt with respect to the second direction of the display panel 151. Such a configuration of the display device 15 is herein referred to as “configuration A”. An example of the configuration A is disclosed in, for example, Japanese Patent Application Laid-open No. 2005-258421.

Consider the case when the display device 15 has the configuration A. Then, depending on the positional relationship with the viewer, sometimes the pixels displaying the parallax images that are supposed to be viewed by the viewer differ from the pixels that the viewer actually views. That is, in the configuration A, the visible area (the area in which a stereoscopic image can be viewed) gets rotated depending on the position (height) in the second direction. Hence, for example, as disclosed in Japanese Patent Application Laid-open No. 2009-251098, if each pixel is corrected using the angular distribution of a single luminance, then the crosstalk phenomenon still persists.

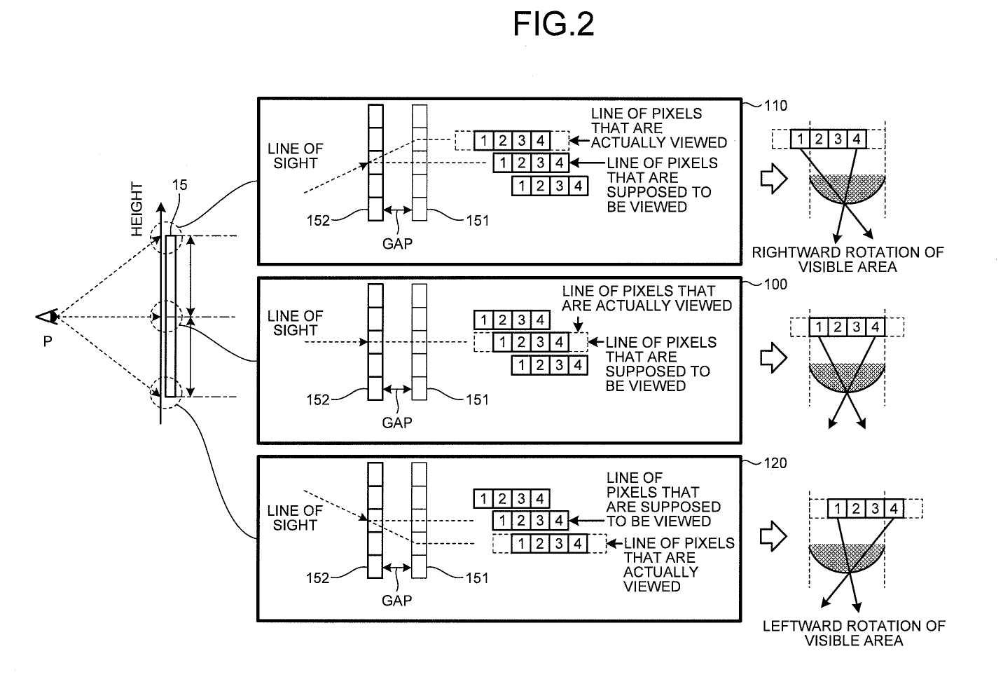

FIG. 2 is an explanatory diagram for explaining the rotation of the visible area when the display device 15 has the configuration A. In the conventional configuration A, the pixels displaying each parallax image are set in the display panel 151 under the assumption that the display panel 151 is viewed from a viewpoint position that is at the same height as the line of those pixels. In FIG. 2, numbers assigned to pixels represent the numbers of corresponding parallax images (parallax numbers). The pixels assigned with the same number represent the pixels displaying the same parallax image. In the example illustrated in FIG. 2, the parallax count is four (parallax numbers 1 to 4). However, it is also possible to have a different parallax count (for example, the parallax count of nine, parallax numbers 1 to 9).

Regarding the pixels at a height in the second direction that is same as the height of a viewpoint position P, the viewer views those pixels which have the parallax numbers that are supposed to be viewed (reference numeral 100 in FIG. 2). That is, from the pixels that are arranged in a line which lies at the same height as the height of the viewpoint position P, an expected visible area is formed with respect to the viewer.

However, since there exists a gap between the display panel 151 and the light ray control unit 152; regarding the pixels lying at a higher level than the viewpoint position P, the viewer happens to view the pixels arranged in a line that lies at a higher level than the pixels of the parallax image that is supposed to be viewed (reference numeral 110 in FIG. 2). That is, from the pixels arranged in a line that lies at a higher level than the viewpoint position P, it was found that such a visible area is formed that has rotated in a direction (in the present example, rotated rightward of the display device 15 from the viewer) than the expected direction.

Similarly, regarding the pixels lying at a lower level than the viewpoint position P, the viewer happens to view the pixels arranged in a line that lies at a lower level than the pixels of the parallax image that is supposed to be viewed (reference numeral 120 in FIG. 2). That is, from the pixels arranged in a line that lies at a lower level than the viewpoint position P, it was found that such a visible area is formed that has rotated in a different direction (in the present example, rotated leftward of the display device 15 from the viewer) than the expected direction.

In this way, when the display device 15 has the configuration A, the visible area gets rotated in the abovementioned manner. Hence, if each pixel is corrected using the angular distribution of a single luminance, then the crosstalk phenomenon still persists.

In that regard, in the first embodiment, in each of a plurality of parallax images that have been obtained; the image processing device 10 specifies a pixel area containing at least a single pixel. Then, based on the angular distribution of the luminance (luminance profile) at the position of the specified pixel area in each parallax image, the image processing device 10 modifies the pixel area in the corresponding parallax image. This enables achieving reduction in the crosstalk phenomenon with accuracy. Meanwhile, in the first embodiment, an “image” can point either to a still image or to a moving image.

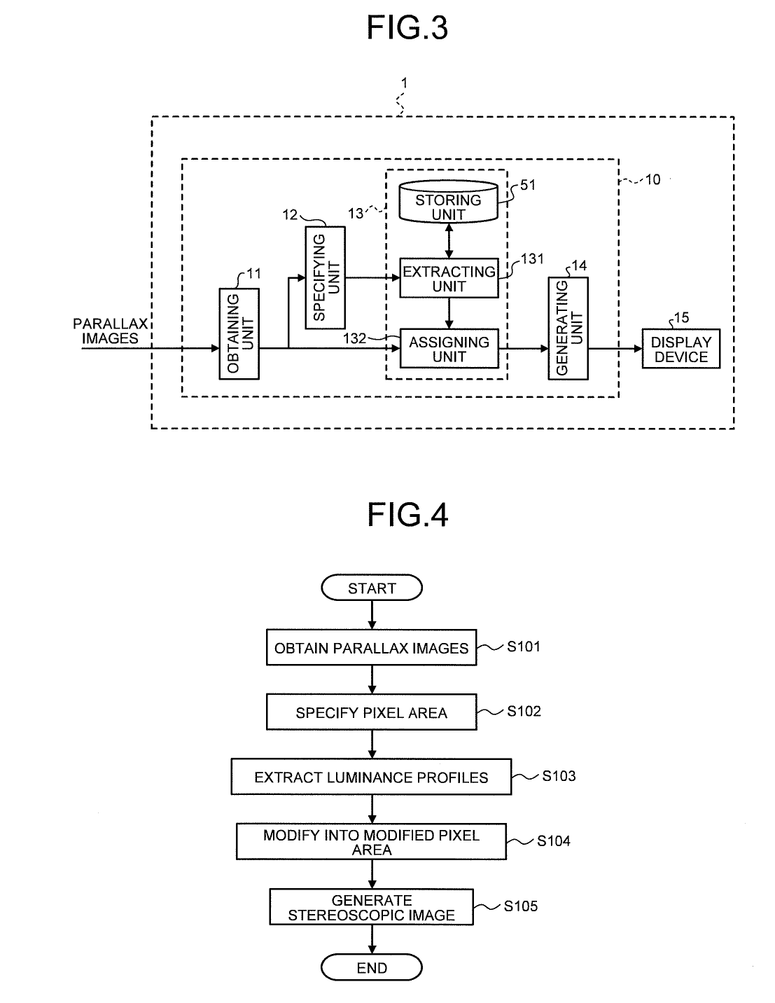

FIG. 3 is a block diagram of the image processing device 10. The image processing device 10 includes an obtaining unit 11, a specifying unit 12, a modifying unit 13, and a generating unit 14. The modifying unit 13 includes a storing unit 51, an extracting unit 131, and an assigning unit 132.

The obtaining unit 11 obtains a plurality of parallax images that are to be displayed as a stereoscopic image.

In each parallax image that has been obtained, the specifying unit 12 specifies, for each parallax image, a pixel area containing at least a single pixel. At that time, in each parallax image, the specifying unit 12 specifies a pixel area to which the position of the parallax image corresponds (for example, a pixel area at the same position). Herein, a pixel area can be specified, for example, in units of pixels, lines, or blocks.

The storing unit 51 is used to store one or more luminance profiles each corresponding to the position of the pixel area in a parallax image. Each luminance profile can be obtained in advance through experiment or simulation. The details regarding the luminance profiles are given later.

The extracting unit 131 extracts, from the storing unit 51, the luminance profile corresponding to the position of the specified pixel area in a parallax image. The assigning unit 132 refers to the extracted luminance profile and accordingly modifies the corresponding specified pixel area into a modified pixel area to which are assigned the pixels that are supposed to be viewed from the viewpoint position of the viewer. Then, the assigning unit 132 sends, to the generating unit 14, the parallax images each having the pixel area modified into a modified pixel area (sends modified images). The generating unit 14 generates a stereoscopic image from the modified images and outputs the stereoscopic image to the display device 15. Then, the display device 15 displays that stereoscopic image.

The obtaining unit 11, the specifying unit 12, the modifying unit 13, and the generating unit 14 can be implemented with a central processing unit (CPU) and a memory used by the CPU. The storing unit 51 can be implemented with the memory used by the CPU or with an auxiliary storage device.

Given above was the explanation regarding the configuration of the image processing device 10.

FIG. 4 is a flowchart for explaining the operations performed in the image processing device 10. The obtaining unit 11 obtains parallax images (S101). The specifying unit 12 specifies a pixel area in each parallax image that has been obtained (S102). The extracting unit 131 extracts, from the storing unit 51, the luminance profiles each corresponding to the position of the pixel area specified in a parallax images (S103). The assigning unit 132 refers to the extracted luminance profiles and accordingly modifies the specified pixel areas into modified pixel areas to which are assigned the pixels that are supposed to be viewed from the viewpoint position of the viewer (S104). The generating unit 14 generates a stereoscopic image from the modified images and outputs the stereoscopic image to the display device 15 (S105).

Step S102 to Step S104 are repeated until the pixel areas in all parallax images are modified.

Given above was the explanation regarding the operations performed in the image processing device 10. Given below is a detailed explanation of the first embodiment.

In the first embodiment, in parallax images that have parallax numbers 1 to K and that are obtained by the obtaining unit 11, the specifying unit 12 specifies pixel areas y(u, j). Then, from the storing unit 51, the extracting unit 131 extracts luminance profiles H(i, j) corresponding to the positions of the pixel areas y(i, j) in the parallax images. By referring to the luminance profiles H(i, j), the assigning unit 132 modifies the pixel areas y(i, j) into modified pixel areas x(i, j).

Herein, (i, j) represent the coordinates indicating the position of the pixel area y(i, j) in a parallax image. The alphabet “i” represents the coordinate (can also be an index) in the first direction of the pixel area; while the alphabet “j” represents the coordinate (can also be an index) in the second direction of the pixel area. It is desirable that the coordinates (i, j) are common in each parallax image.

Hence, in the parallax image having the parallax number K, a pixel area y_{K} can be expressed as y_{K}(i, j). Similarly, in all parallax images (having the parallax numbers 1 to K), pixel areas y₁ to y_{K} can be expressed using Equation 1.

y(i,j)=(y₁(i,j), . . . , y_{K}(i,j))^{T} (1)

Herein, T points to transposition. Thus, in Equation 1, the pixel areas in all of the obtained parallax images are expressed as vectors. Meanwhile, y₁ to y_{K} represent pixel values.

At Step S102 illustrated in FIG. 4, the specifying unit 12 specifies the pixel area y(i, j) in each parallax image that has been obtained.

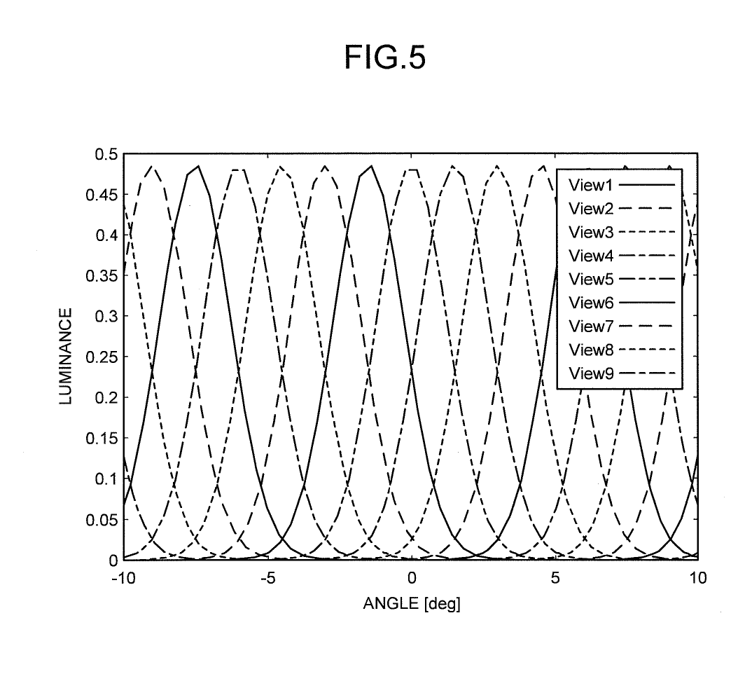

FIG. 5 is an exemplary diagram of luminance profiles. In FIG. 5 are illustrated the luminance profiles corresponding to nine parallaxes. The luminance profiles illustrated in FIG. 5 represent the angular distributions of the luminance of the light rays coming out from the pixel areas (for example, pixels corresponding to parallax numbers 1 to 9) that display parallax images. Herein, the horizontal axis represents the angle (for example, angle in the first direction) against the pixel areas. In FIG. 5, “View1” to “View9” correspond to the pixels having the parallax numbers 1 to 9, respectively. In the luminance profiles illustrated in FIG. 5, the direction straight in front of the pixel areas is assumed to be at an angle 0 (deg). Meanwhile, the vertical axis represents the luminance (light ray intensity). For each pixel area, the luminance profile can be measured in advance using a luminance meter or the like.

Thus, if a pixel area that is displayed on the display device 15 is viewed by the viewer from a viewpoint position at an angle θ, then a light ray that has the pixel value of each pixel overlapped according to the luminance profile (for example, a light ray of mixed colors) reaches the eyes of the viewer. As a result, the user happens to view a multiply-blurred stereoscopic image.

The storing unit 51 stores therein the data of the luminance profile H(i, j) corresponding to the coordinates (i, j) of each pixel area y(i, j). For example, in the storing unit 51, the coordinates (i, j) of a pixel area y(i, j) can be stored in a corresponding manner with the luminance profile for those coordinates. The luminance profile H(i, j) can be expressed using Equation 2.

$$H ( i , j ) = [ \begin{matrix}{h}_{1}^{( i , j )} ( {θ}_{0} ) & … & {h}_{K}^{( i , j )} ( {θ}_{0} ) \\ & ⋮ & \\ {h}_{1}^{( i , j )} ( {θ}_{Q} ) & … & {h}_{K}^{( i , j )} ( {θ}_{Q} )\end{matrix} ] \qquad ( 2 )$$

In FIG. 2, h_{K}^{(i, j)} (θ) represents the luminance, at the coordinates (i, j) of the pixel area y(i, j), of the light rays coming out in the direction of the angle θ from the pixels displaying the parallax number K. Meanwhile, angles θ_{O} to θ_{Q} can be set in advance through experiment or simulation.

At Step S103 illustrated in FIG. 4, the extracting unit 131 extracts, from the storing unit 51, the luminance profile H(i, j) corresponding to the coordinates (i, j) of the specified pixel area y(i, j).

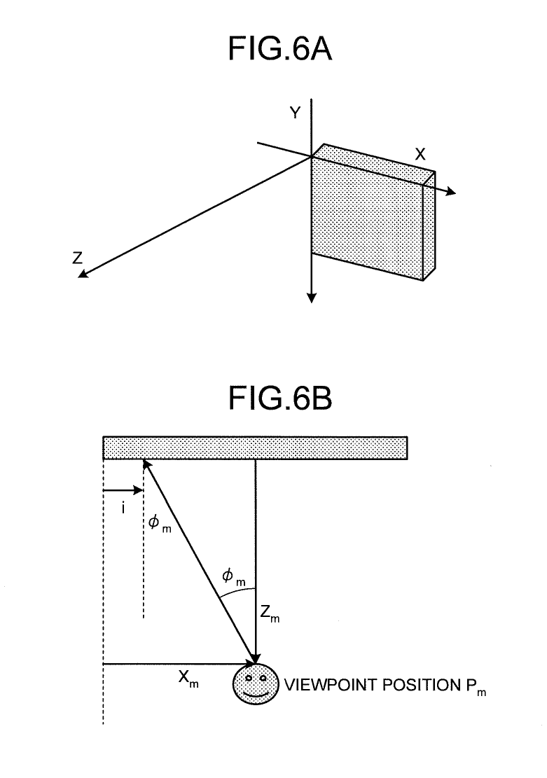

FIGS. 6A and 6B are explanatory diagrams for explaining the positional relationship between the display device 15 and the viewpoint. As illustrated in FIG. 6A, an origin is set on the display device 15 (for example, the top left point of the display device 15). The X axis is set in a first direction passing through the origin, while the Y axis is set in a second direction passing through the origin. Moreover, the Z axis is set in a direction perpendicular to the first direction as well as perpendicular to the second direction. Z represents the distance from the display device 15 to the viewpoint.

As illustrated in FIG. 6B, the viewpoint position of the viewer is assumed to be Pₘ=(Xₘ, Yₘ, Zₘ). In the first embodiment, the viewpoint position Pₘ is fixed in advanced. Moreover, there can be more than one viewpoint positions Pₘ (where, m=1, 2, . . . , M). When the pixel area y(i, j) having the coordinates (i, j) is viewed from the viewpoint position Pₘ, an angle φₘ that is formed between the viewing direction and the Z direction can be expressed using Equation 3.

$${φ}_{m} = {tan}^{- 1} ( \frac{{X}_{m} - i}{{Z}_{m}} ) \qquad ( 3 )$$

Accordingly, when the pixel area y(i, j) is viewed from the viewpoint position Pₘ, a luminance h^{(i, j)} (φₘ) of the light ray that reaches in the direction of the angle φₘ can be expressed using Equation 4.

h^{(i,j)}(φₘ)=(h₁^{(i,j)}(φₘ), . . . , h_{K}^{(i,j)}(φₘ)) (4)

From the luminance profile H(i, j) that has been extracted, the assigning unit 132 extracts a luminance profile component (a row component of a determinant in Equation 2) equivalent to the angle φₘ (θ=φₘ). If a luminance profile component equivalent to the angle φₘ is absent, then the assigning unit 132 can calculate the luminance profile component by interpolation from other luminance profile components (θ_{O} to θ_{Q}). Alternatively, the assigning unit 132 can extract the luminance profile component at such an angle θ which is closest to the angle φₘ.

Using the luminance profiles component that has been extracted, the assigning unit 132 obtains a light ray luminance A(i, j) that represents the luminance of the pixel area y(i, j) in the case when the pixel area y(i, j) is viewed from each of the viewpoint positions Pₘ. The light ray luminance A(i, j) can be expressed using Equation 5.

$$A ( i , j ) = [ \begin{matrix}{h}_{1}^{( i , j )} ( {φ}_{1} ) & … & {h}_{K}^{( i , j )} ( {φ}_{1} ) \\ & ⋱ & \\ {h}_{1}^{( i , j )} ( {φ}_{M} ) & … & {h}_{K}^{( i , j )} ( {φ}_{M} )\end{matrix} ] \qquad ( 5 )$$

At Step S104 illustrated in FIG. 4, the assigning unit 132 refers to the pixel area y(i, j) and the light ray luminance A(i, j), and accordingly obtains a modified pixel area x(i, j). That is, with the aim of minimizing the error with respect to the pixel area y(i, j), the assigning unit 132 obtains the modified pixel area x(i, j) using Equation 6, and then assigns it to each pixel.

By(i,j)−A(i,j) (6)

In Equation 6, a matrix B specifies which parallax image (parallax number K) is viewed from which viewpoint positions (viewpoint positions Pₘ). For example, for the parallax number K=5 and for the number of viewpoint positions M=2, the matrix B can be expressed as given in Equation 7.

$$B = [ \begin{matrix}0 & 0 & 1 & 0 & 0 \\ 0 & 0 & 0 & 1 & 0\end{matrix} ] \qquad ( 7 )$$

In Equation 7, the matrix B specifies that the parallax image having the parallax number K=3 is viewed from the viewpoint position Pₘ=P₁ and specifies that the parallax image having the parallax number K=4 is viewed from the viewpoint position Pₘ=P₂. Instead of the matrix B expressed in Equation 6, any other matrix can be used in which the number of rows represents the number of parallaxes and the number of columns represents the number of viewpoint positions.

The assigning unit 132 can obtain a modified pixel area x(i, j)=x′(i, j) using, for example, Equation 8.

$$\hat{x} ( i , j ) = {arg min}_{x} {( By ( i , j ) - A ( i , j ) x ( i , j ) )}^{T} ( By ( i , j ) - A ( i , j ) x ( i , j ) ) \qquad ( 8 )$$

Equation 8 is used to obtain such x(i, j) that minimizes (By(i, j)−A(i, j)x(i, j))^{T}(By(i, j)−A(i, j)x(i, j)).

The assigning unit 132 can obtain the modified pixel area x(i, j) by analytically-calculating By(i, j)−A(i, j)x(i, j)=0. Alternatively, the assigning unit 132 can obtain the modified pixel area x(i, j) by implementing the method of steepest descent or the nonlinear optimization method. Thus, the assigning unit 132 assigns the pixel values in such a way that each pixel in the modified pixel area x(i, j) satisfies Equation 8.

According to the first embodiment, a pixel area in a parallax image is modified by referring to the luminance profile or the light ray luminance in which the positional relationship between that pixel area and a predetermined viewpoint position is taken into consideration. This enables achieving reduction in the occurrence of the crosstalk phenomenon with accuracy.

Meanwhile, the obtaining unit 11 can be configured to generate parallax images from a single image that has been input. Alternatively, the obtaining unit 11 can be configured to generate parallax images from a stereo image that has been input. Besides, as long as the parallax images contain areas having a mutually different parallax, the parallax images can also contain areas having the same parallax.

### First Modification Example

The display panel 151 can also have a horizontal stripe arrangement in which the sub-pixels of the same color components are arranged in the first direction and each color component is repeatedly arranged in the second direction. In that case, the light ray control unit 152 is disposed in such a way that the extending direction of the optical openings is parallel to the second direction of the display panel 151. Such a configuration of the display device 15 is herein referred to as “configuration B”.

When the display device has the configuration B, sometimes the display panel 151 and the light ray control unit 152 do not lie completely parallel to each other due to a manufacturing error. Even in such a case, if each pixel area is modified using the luminance profile as explained in the first embodiment, reduction in the occurrence of the crosstalk phenomenon can be achieved with accuracy. Thus, according to the first modification example, it is possible to reduce the crosstalk phenomenon that may occur due to a manufacturing error.

### Second Modification Example

Irrespective of whether the display device 15 has the configuration A or the configuration B, the gap between the display panel 151 and the light ray control unit 152 may vary depending on the positions thereof. Such a condition in which the gap varies depending on the positions is herein referred to as “gap irregularity”. Even in such a case, if each pixel area is modified using the luminance profile as explained in the first embodiment, reduction in the occurrence of the crosstalk phenomenon can be achieved with accuracy. Thus, according to the second modification example, it is possible to reduce the crosstalk phenomenon that may occur due to the gap irregularity resulted during the manufacturing process.

### Second Embodiment

In an image processing device 20 according to a second embodiment, the pixel values of the pixel area in each parallax image are modified using a filter coefficient (a luminance filter) that corresponds to the luminance profile used in the first embodiment. This enables achieving reduction in the occurrence of the crosstalk phenomenon with accuracy and at a lower processing cost.

When a pixel area is viewed from a predetermined viewpoint position, the luminance filter serves as a coefficient that performs conversion of the corresponding parallax image y(i, j) in such a way that the light ray that reaches the viewpoint position is the light ray coming out from the pixel area (for example, pixels) displaying the parallax image that is supposed to be viewed. Explained below are the differences with the first embodiment.

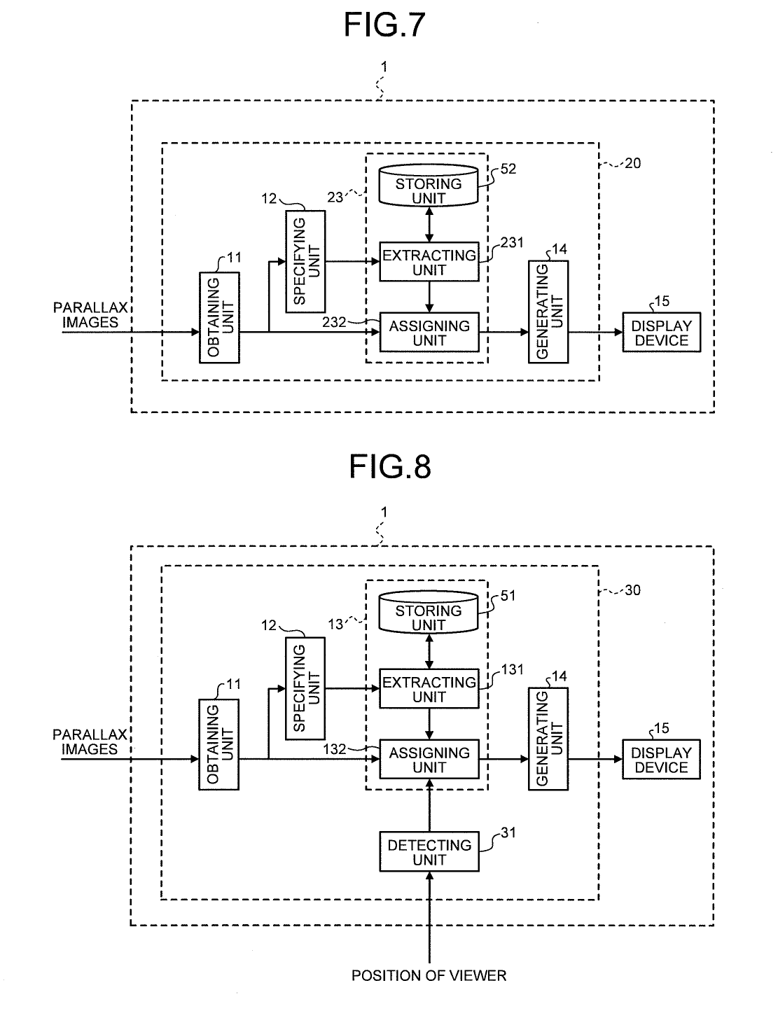

FIG. 7 is a block diagram of the image processing device 20. Herein, in the image processing device 20, a modifying unit 23 substitutes for the modifying unit 13 of the image processing device 10. The modifying unit 23 includes a storing unit 52, an extracting unit 231, and an assigning unit 232.

The storing unit 52 is used to store one or more luminance filters G(i, j) corresponding to the positions of pixel areas y(i, j) in the parallax images. It is desirable that the luminance filters G(i, j) are equivalent to the luminance profiles H(i, j) according to the first embodiment. The extracting unit 231 extracts, from the storing unit 52, the luminance filter G(i, j) corresponding to the specified pixel area y(i, j).

Using the luminance filter G(i, j), the assigning unit 232 performs filtering on the pixel area y(i, j) to calculate the modified pixel area x(i, j) and then assigns the modified pixel area x(i, j) to each pixel. For example, the assigning unit 232 can calculate the modified pixel area x(i, j) by multiplying the luminance filter G(i, j) by the pixel area y(i, j).

The extracting unit 231 and the assigning unit 232 can be implemented using a CPU and a memory used by the CPU. The storing unit 52 can be implemented with the memory used by the CPU or with an auxiliary storage device.

According to the second embodiment, reduction in the occurrence of the crosstalk phenomenon can be achieved with accuracy and at a lower processing cost.

### Modification Example

The storing unit 52 may not store therein all of the luminance filters G(i, j) corresponding to all pixel areas y(i, j). In such a case, with respect to one or more luminance filters G(i, j) that are stored in the storing unit 52, the extracting unit 231 performs interpolation to generate the luminance filter G(i, j) corresponding to each pixel area y(i, j).

For example, assume that the storing unit 52 stores therein four luminance filters, namely, G(0, 0), G(3, 0), G(0, 3), and G(3, 3). In that case, the extracting unit 231 can obtain the luminance filter G(2, 2) corresponding to the pixel area y(2, 2) using Equation 9.

G(2,2)=αG(0,0)+βG(3,0)+γG(0,3)+λG(3,3) (9)

In Equation 9; α, β, γ, and λ are weight coefficients and can be obtained using the internal ratio of coordinates.

Thus, according to this modification example, it becomes possible to put a cap on the memory capacity of the storing unit 52.

### Third Embodiment

An image processing device 30 according to a third embodiment differs from the abovementioned embodiments in that fact that the viewpoint positions of one or more viewers with respect to the display device 15 are detected, and the pixel values of the pixels included in the specified pixel area y(i, j) are modified in such a way that the parallax image that is supposed to be viewed from the detected viewpoint positions of the viewers is displayed. Explained below are the differences with the earlier embodiments.

FIG. 8 is a block diagram of the image processing device 30. Herein, in comparison to the image processing device 10, the image processing device 30 additionally includes a detecting unit 31, which detects the viewpoint positions of one or more viewers with respect to the display device 15. For example, the detecting unit 31 detects a position P_{L}=(X_{L}, Y_{L}, Z_{L}) of the left eye and a position P_{R}=(X_{R}, Y_{R}, Z_{R}) of the right eye of a viewer in the real space using a camera or a sensor. If there are a plurality of viewers, the detecting unit 31 can detect the position P_{L}=(X_{L}, Y_{L}, Z_{L}) of the left eye and a position P_{R}=(X_{R}, Y_{R}, Z_{R}) of the right eye of each viewer. Then, the detecting unit 31 sends the detected viewpoint positions of the viewers to the assigning unit 132. Herein, the detecting unit 31 can be implemented with a CPU and a memory used by the CPU.

Then, the assigning unit 132 refers to the extracted luminance profile and accordingly modifies the specified pixel area y(i, j) into a modified pixel area to which are assigned the pixels that are supposed to be viewed from the detected viewpoint position of the viewer.

According to the third embodiment, processing can be done in an adoptive manner according to the position of a viewer or according to the number of viewers. This enables achieving further reduction in the occurrence of the crosstalk phenomenon with accuracy.

Meanwhile, in the third embodiment, the configuration of the image processing device 30 is explained in comparison with the image processing device 10. However, the explanation regarding the configuration of the image processing device 30 is also identical in comparison with the image processing device 20.

Thus, according to the embodiments described above, reduction in the occurrence of the crosstalk phenomenon can be achieved with accuracy.

Meanwhile, the abovementioned image processing device can be implemented using, for example, a general-purpose computer apparatus as the basic hardware. That is, the obtaining unit 11, the specifying unit 12, the modifying unit 13, 23 and the generating unit 14 can be implemented by executing programs in a processor installed in the abovementioned computer apparatus. At that time, the image processing device can be implemented by installing in advance the abovementioned programs in the computer apparatus. Alternatively, the image processing device can be implemented by storing the abovementioned programs in a memory medium such as a CD-ROM or by distributing the abovementioned programs via a network, and then by appropriately installing the programs in the computer apparatus. Moreover, the storing unit 51 and the storing unit 52 can be implemented by appropriately making use of a memory or a hard disk that is either built-in in the abovementioned computer apparatus or that is attached externally, or can be implemented by appropriately making use of a memory medium such as a CD-R, a CD-RW, a DVD-RAM, or a DVD-R.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising:
a specifying unit configured to specify, from among a plurality of parallax images each having a mutually different parallax, a pixel area containing at least a single pixel; and
a modifying unit configured to, depending on a positional relationship between each pixel in the pixel area specified from among the parallax images and a viewpoint position of a viewer, modify the pixel area into a modified pixel area that contains a pixel which is supposed to be viewed from the viewpoint position.

2. The device according to claim 1, wherein the modifying unit holds luminance distribution of rays coming out from the pixel area and, based on the luminance distribution corresponding to the viewpoint position, assigns each pixel included in the modified pixel area.

3. The device according to claim 2, wherein the modifying unit assigns each pixel included in the modified pixel area by performing filtering using a filter coefficient, which correlates with the luminance distribution corresponding to the positional relationship between each pixel in the pixel area from among the parallax images and the viewpoint position of the viewer.

4. The device according to claim 3, wherein, depending on the positional relationship between each pixel in the pixel area from among the parallax images and the viewpoint position of the viewer, the modifying unit performs interpolation of the filter coefficient and then assigns each pixel included in the modified pixel area by performing filtering using the filter coefficient that has been subjected to interpolation.

5. The device according to claim 2, wherein the modifying unit further includes
a storing unit configured to store therein data of the luminance distribution corresponding to the positional relationship between each pixel in the pixel area from among the parallax images and the viewpoint position of the viewer;
an extracting unit configured to extract, from the storing unit, the data of the luminance distribution corresponding to the positional relationship between each pixel in the pixel area from among the parallax images and the viewpoint position of the viewer; and
an assigning unit configured to refer to the extracted data of the luminance distribution and accordingly assign each pixel included in the modified pixel area.

6. The device according to claim 3, wherein the modifying unit further includes
a storing unit configured to store therein the filter coefficient corresponding to the positional relationship between each pixel in the pixel area and the viewpoint position of the viewer;
an extracting unit configured to extract, from the storing unit, the filter coefficient corresponding to the positional relationship between each pixel in the pixel area and the viewpoint position of the viewer; and
an assigning unit configured to refer to the extracted filter coefficient and accordingly assign each pixel included in the modified pixel area.

7. The device according to claim 1, further comprising a detecting unit configured to detect a viewpoint position of each of one or more viewers.

8. An image processing method comprising:
specifying, from among a plurality of parallax images each having a mutually different parallax, a pixel area containing at least a single pixel; and
modifying, depending on a positional relationship between each pixel in the pixel area specified from among the parallax images and a viewpoint position of a viewer, the pixel area into a modified pixel area that contains a pixel which is supposed to be viewed from the viewpoint position.

9. A autostereoscopic display apparatus comprising:
a display panel having a plurality of pixels arranged thereon in a first direction and in a second direction that bisects the first direction;
a light ray control unit disposed opposite to the display panel and configured to control an outgoing direction of a light ray coming out from each of the pixels;
a specifying unit configured to specify, from among a plurality of parallax images each having a mutually different parallax, a pixel area that contains at least a single pixel and that is to be displayed on the display panel; and
a modifying unit configured to, depending on a positional relationship between each pixel in the pixel area specified from among the parallax images and a viewpoint position of a viewer, modify the pixel area into a modified pixel area that contains a pixel which is supposed to be viewed from the viewpoint position of the viewer.
